(19) United States
(12) Patent Application Publication
(10) Pub. No.: US 2023/0325658 A1
(43) Pub. Date: Oct. 12, 2023

(54) CONDITIONAL OUTPUT GENERATION THROUGH DATA DENSITY GRADIENT ESTIMATION

(71) Applicant: Google LLC, Mountain View, CA (US)

(72) Inventors: Nanxin Chen, Baltimore, MD (US); Byungha Chun, Tokyo (JP); William Chan, Toronto (CA); Ron J. Weiss, New York, NY (US); Mohammad Norouzi, Toronto (CA); Yu Zhang, Mountain View, CA (US); Yonghui Wu, Fremont, CA (US)

(21) Appl. No.: 18/010,426

(22) PCT Filed: Sep. 2, 2021
(86) PCT No.: PCT/US2021/048931

§ 371 Date: Dec. 14, 2022

Related U.S. Application Data
(60) Provisional application No. 63/073,867, filed on Sep. 2, 2020.

(51) Int. Cl. G06V 10/82; G06N 3/08; G10L 13/02; G10L 25/18; G10L 25/30; G06V 10/764; G06V 10/26

(52) U.S. Cl. CPC G06N 3/08; G06V 10/26; G06V 10/764; G06V 10/82; G10L 13/02; G10L 25/18; G10L 25/30

(57) ABSTRACT

Methods, systems, and apparatus, including computer programs encoded on a computer storage medium, for generating outputs conditioned on network inputs using neural networks. In one aspect, a method comprises obtaining the network input; initializing a current network output; and generating the final network output by updating the current network output at each of a plurality of iterations, wherein each iteration corresponds to a respective noise level, and wherein the updating comprises, at each iteration: processing a model input for the iteration comprising (i) the current network output and (ii) the network input using a noise estimation neural network that is configured to process the model input to generate a noise output, wherein the noise output comprises a respective noise estimate for each value in the current network output; and updating the current network output using the noise estimate and the noise level for the iteration.

### CROSS-REFERENCE TO RELATED APPLICATION

This application claims priority to U.S. Application No. 63/073,867, filed Sep. 2, 2020, the disclosure of which is incorporated herein by reference.

### BACKGROUND

This specification relates to generating outputs conditioned on network inputs using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that generates a network output conditioned on a network input.

According to a first aspect there is provided a method of generating a final network output comprising a plurality of outputs conditioned on a network input, the method comprising: obtaining the network input; initializing a current network output; and generating the final network output by updating the current network output at each of a plurality of iterations, wherein each iteration corresponds to a respective noise level, and wherein the updating comprises, at each iteration: processing a model input for the iteration comprising (i) the current network output and (ii) the network input using a noise estimation neural network that is configured to process the model input to generate a noise output, wherein the noise output comprises a respective noise estimate for each value in the current network output; and updating the current network output using the noise estimate and the noise level for the iteration.

In some implementations, the network input is a spectrogram of an audio segment, and wherein the final network output is a waveform for the audio segment.

In some implementations, the audio segment is a speech segment.

In some implementations, the spectrogram has been generated from a text segment or linguistic features of the text segment by a text-to-speech model.

In some implementations, the spectrogram is a mel spectrogram or a log mel spectrogram.

In some implementations, updating the current network output using the noise estimate and the noise level for the iteration comprises: generating an update for the iteration from at least the noise estimate and the noise level corresponding to the iteration; and subtracting the update from the current network output to generate an initial updated network output.

In some implementations, updating the current network output further comprises: modifying the initial updated network output based on the noise level for the iteration to generate a modified initial updated network output.

In some implementations, for the last iteration, the modified initial updated network output is the updated network output after the last iteration and, for each iteration prior to the last iteration, the updated network output after the last iteration is generated by adding noise to the modified initial updated network output.

In some implementations, initializing the current network output comprises: sampling each of a plurality of initial values for the current network output from a corresponding noise distribution.

In some implementations, the model input at each iteration includes iteration-specific data that is different for each iteration.

In some implementations, the model input for each iteration includes the noise level corresponding to the iteration.

In some implementations, the model input for each iteration includes an aggregate noise level for the iteration generated from the noise levels corresponding to the iteration and to any iterations after the iteration in the plurality of iterations.

In some implementations, the noise estimation neural network comprises: a noise generation neural network comprising a plurality of noise generation neural network layers and configured to process the network input to map the network input to the noise output, and a network output processing neural network comprising a plurality of network output processing neural network layers configured to process the current network output to generate an alternative representation of the current network output, wherein: at least one of the noise generation neural network layers receives an input that is derived from (i) an output of another one of the noise generation neural network layers, (ii) an output of a corresponding network output processing neural network layer, and (iii) the iteration-specific data for the iteration.

In some implementations, the final network output has a higher dimensionality than the network input, and wherein the alternative representation has a same dimensionality as the network input.

In some implementations, the noise estimation neural network comprises a respective Feature-wise Linear Modulation (FiLM) module corresponding to each of the at least one noise generation neural network layers, wherein the FiLM module corresponding to a given noise generation neural network layer is configured to process (i) the output of the other one of the noise generation neural network layers, (ii) the output of the corresponding network output processing neural network layer, and (iii) the iteration-specific data for the iteration to generate the input to the noise generation neural network layer.

In some implementations, the FiLM module corresponding to the given noise generation neural network layer is configured to: generate a scale vector and a bias vector from (ii) the output of the corresponding network output processing neural network layer, and (iii) the iteration-specific data for the iteration; and generate the input to the given noise generation neural network layer by applying an affine transformation to the output of (i) the other one of the noise generation neural network layers.

In some implementations, the at least one of the noise generation neural network layers includes an activation function layer that applies a non-linear activation function to the input to the activation function layer.

In some implementations, the other one of the noise generation neural network layers corresponding to the activation function layer is a residual connection layer or a convolutional layer.

In some implementations, a method of training the noise estimation neural network comprises repeatedly performing the following operations: obtaining a training network input and a corresponding training network output; selecting iteration-specific data from a set that includes the iteration-specific data for all of the plurality of iterations; sampling a noisy output that includes a respective noise value for each value in the training network output; generating a modified training network output from the noisy output and the corresponding training network output; processing a model input that comprises (i) the modified training network output, (ii) the training network input, and (iii) the iteration-specific data using the noise estimation neural network to generate a training noise output; and determining an update to the network parameters of the noise estimation neural network from a gradient of an objective function that measures an error between the sampled noisy output and the training noise output.

In some implementations, the objective function measures a distance between the sampled noisy output and the training noise output.

In some implementations, the distance is an L1 distance.

Particular embodiments of the subject matter described in this specification can be implemented so as to realize one or more of the following advantages.

The described techniques generate network outputs in a non-autoregressive manner conditioned on network inputs. Generally, auto-regressive models have been shown to generate high quality network outputs but require a large number of iterations, resulting in high latency and resource, e.g., memory and processing power, consumption. This is because auto-regressive models generate each given output within a network output one by one, with each being conditioned on all of the outputs that precede the given output within the network output.

The described techniques, on the other hand, start from an initial network output, e.g., a noisy output that includes values sampled from a noise distribution, and iteratively refine the network output via a gradient-based sampler conditioned on the network input, i.e. an iterative denoising process may be used. As a result, the approach is non-autoregressive and requires only a constant number of generation steps during inference. For example, for audio synthesis conditioned on a spectrogram, the described techniques can generate high fidelity audio samples in very few iterations, e.g., six or fewer, that compare to or even exceed those generated by state of the art autoregressive models with greatly reduced latency and while using many fewer computational resources. In addition, the described techniques can generate higher quality (e.g. higher fidelity) samples than those produced by existing non-autoregressive models.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example conditional output generation system.

FIG. 2 is a flow diagram of an example process for generating outputs conditioned on network inputs.

FIG. 3 is a block diagram of an example noise estimation neural network.

FIG. 4 is a block diagram of an example network output processing neural network block.

FIG. 5 is a block diagram of an example Feature-wise Linear Modulation (FiLM) module.

FIG. 6 is a block diagram of an example noise generation neural network block.

FIG. 7 is a flow diagram of an example process for training a noise estimation neural network.

Like reference numbers and designations in the various drawings indicate like elements.

### DETAILED DESCRIPTION

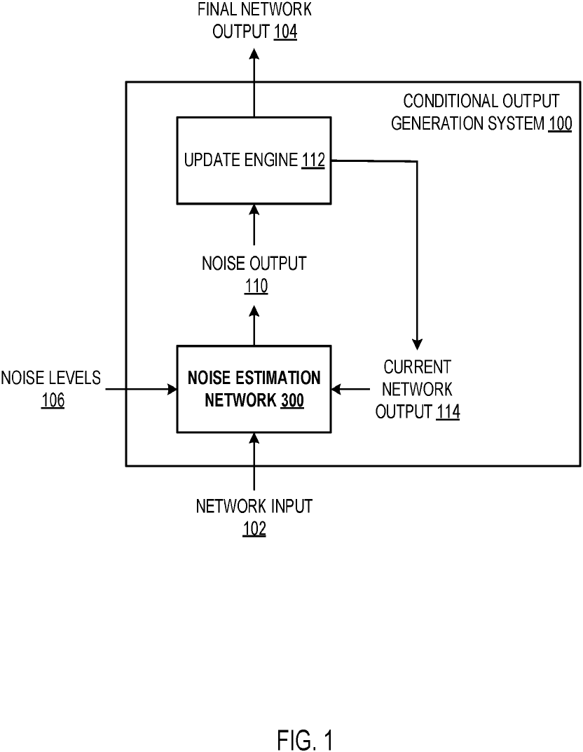

FIG. 1 shows an example conditional output generation system 100. The conditional output generation system 100 is an example of a system implemented as computer programs on one or more computers in one or more locations in which the systems, components, and techniques described below are implemented.

The conditional output generation system 100 generates a final network output 104 conditioned on a network input 102.

The conditional output generation system 100 herein is widely applicable and is not limited to one specific implementation. However, for illustrative purposes, a small number of example implementations are described below.

For example, the system can be configured to generate a waveform of audio conditioned on a spectrogram, e.g., a mel-spectrogram or a spectrogram where the frequencies are in a different scale, of the audio. As a particular example of this, the spectrogram can be a spectrogram of a speech segment and the waveform can be the waveform for the speech segment. For example, the spectrogram can be the output of a text-to-speech machine learning model that converts text or linguistic features of the text to a spectrogram of an utterance of the text being spoken.

As another example, the system can be configured to perform an image processing task on the network input to generate the network output. For example, the network input could be a class of object (e.g., represented by a one-hot vector) specifying a class of image object to be generated, and the network output can be a generated image (e.g., represented by an intensity value or set of RGB values for each pixel in the image) of the class of object.

As another particular example, the task can be conditional image generation and the network input can be a sequence of text and the network output can be an image that reflects the text. For example, the sequence of text can include a sentence or sequence of adjectives describing the scene in the image.

In another particular example, the task can be image embedding generation, and the network input can be an image and the network output can be a numeric embedding of the input image that characterizes the image.

As yet another particular example, the task can be object detection, and the network input can be an image and the network output can identify locations in the input image at which particular types of objects are depicted, e.g., can specify bounding boxes in the input image that contain depictions of objects.

As yet another particular example, the task can be image segmentation and the network input can be an image and the network output can be a segmentation output that assigns each of a plurality of pixels of the input image to a category from a set of categories, e.g., that assigns to each pixel a respective score for each of the categories that represents the likelihood that the pixel belongs to the category.

More generally, the task can be any task that outputs continuous data conditioned on a network input.

To generate the final network output 104 conditioned on the network input 102, the conditional output generation system 100 obtains the network input 102 and initializes a current network output 114. For example, the system 100 can initialize the current network output 114 (that is, can generate the first instance of the current network output 114), by sampling each value in the current network output from a corresponding noise distribution (e.g., a Gaussian distribution, such as N(0, I), where I is an identity matrix). That is, the initial current network output 114 includes the same number of values as the final network output 104, but with each value being sampled from a corresponding noise distribution.

The system 100 then generates the final network output 104 by updating the current network output 114 at each of multiple iterations. In other words, the final network output 104 is the current network output 114 after the last iteration of the multiple iterations.

In some cases, the number of iterations is fixed.

In other cases, the system 100 or another system can adjust the number of iterations based on a latency requirement for the generation of the final network output. That is, the system 100 can select the number of iterations so that the final network output 104 will be generated to satisfy the latency requirement.

In yet other cases, the system 100 or another system can adjust the number of iterations based on a computational resource consumption requirement for the generation of the final network output 104, i.e., can select the number of iterations so that the final network output will be generated to satisfy the requirement. For example, the requirement can be a maximum number of floating operations (FLOPS) to be performed as part of generating the final network output.

At each iteration, the system processes a model input for the iteration that includes (i) the current network output 114, (ii) the network input 102, and optionally (iii) iteration-specific data for the iteration using a noise estimation neural network 300. The iteration specific data is generally derived from noise levels 106 (e.g., where each noise level corresponds to a particular iteration). The system can update the current network output using the noise levels 106 as a scale for each iteration of update. That is, each noise level in the noise levels 106 can correspond to a particular iteration, and the respective noise level for an iteration can guide the scale of the update to the current network output 114 at the iteration.

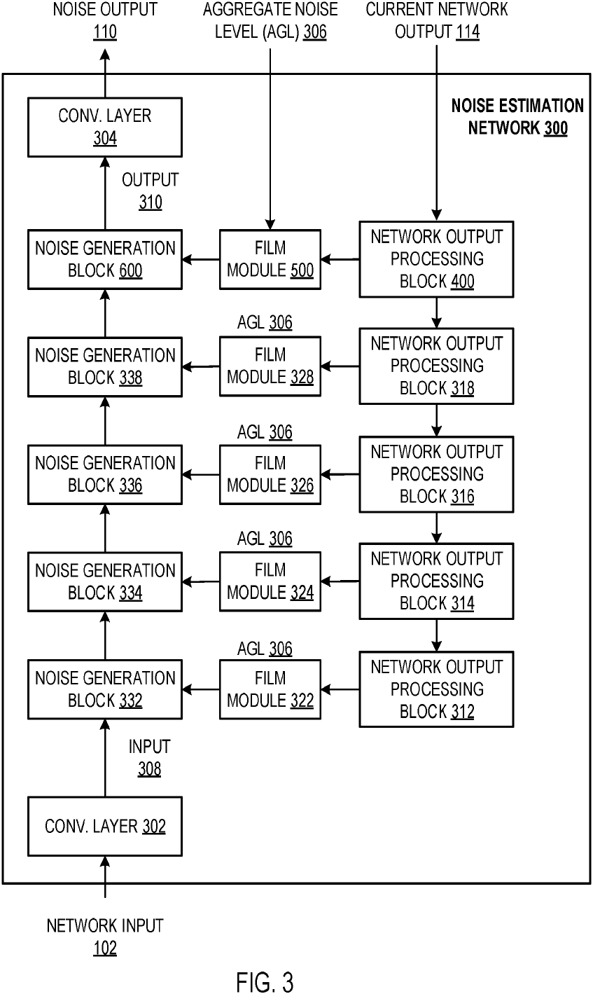

The noise estimation neural network 300 is a neural network that has parameters (“network parameters”) and that is configured to process the model input in accordance with the current values of the network parameters to generate a noise output 110 that includes a respective noise estimate for each value in the current network output 114. The details of the noise estimation neural network are discussed with further detail with respect to FIG. 3 below.

Generally, the noise estimate for a given value in the current network output is an estimate of the noise that has been added to the corresponding actual value in the actual network output for the network input in order to generate the given value. That is, the noise estimate defines how the actual value, if known, would need to be modified to generate the given value in the current network output given a noise level corresponding to the current iteration. In other words, the given value could be generated by applying the noise estimate to the actual value in accordance with the noise level for the current iteration.

This noise estimate can be interpreted as an estimate of the gradient of the data density, and therefore the generation process can be seen as a process that iteratively generates the network output through data density estimation.

The system 100 then updates the current network output 114 in the direction of the noise estimate using an update engine 112.

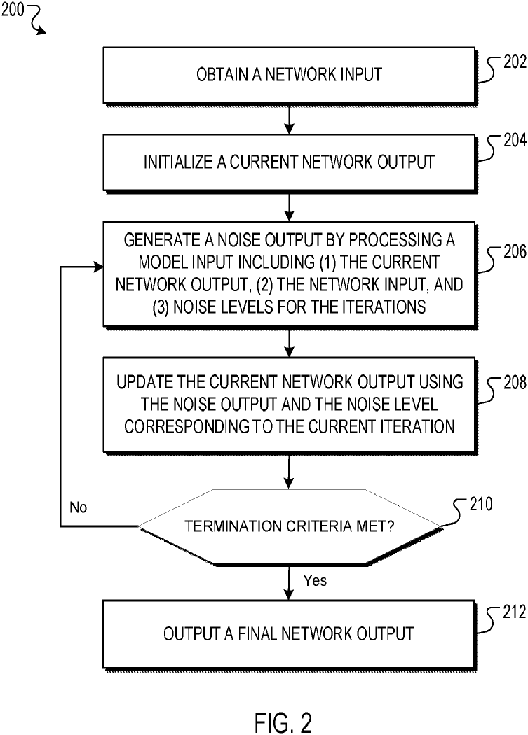

In particular, the update engine 112 updates the current network output 114 using the noise estimate and the corresponding noise level for the iteration. That is, the update engine 112 updates each value of the current network output 114 using the corresponding noise estimate of the noise output 110 and the corresponding noise level at the iteration, as is discussed in further detail with respect to FIG. 2.

After the final iteration, the conditional output generation system 100 outputs the updated network output 114 as the final network output 104. For example, in implementations where the final network output 104 represents an audio waveform, the system can play back the audio using a speaker, or transmit the audio for playback, etc. In another example, in implementations where the final network output 104 represents an image, the system can show the image on a user display, or transmit the image for display, etc. In some implementations, the system 100 can save the final network output 104 to a data store, or transmit the final network output 104 to be stored.

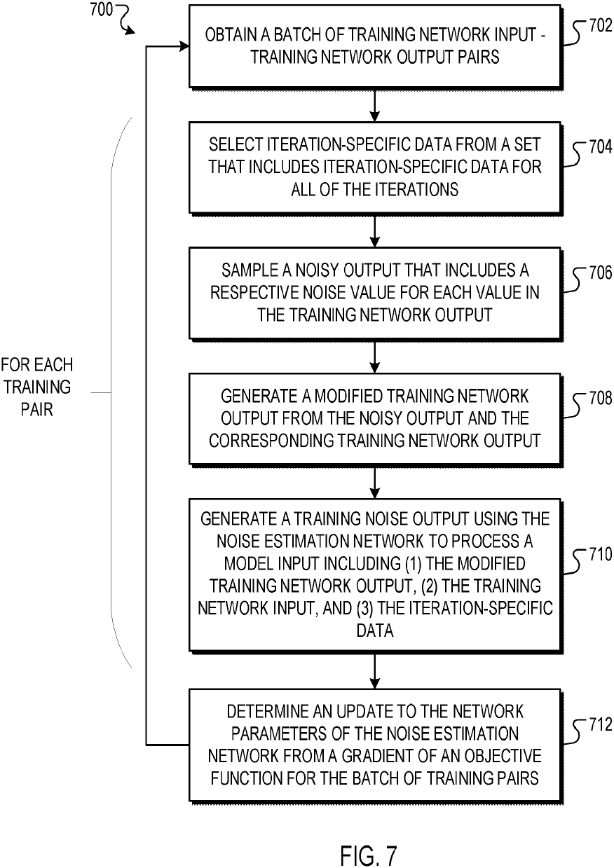

Prior to the system 100 using the noise estimation neural network 300 to generate final network outputs, the system 100 or another system trains the noise estimation neural network 300 on training data. The training is described below with reference to FIG. 7.

FIG. 2 is a flow diagram of an example process 200 for generating outputs conditioned on network inputs. For convenience, the process 200 will be described as being performed by a system of one or more computers located in one or more locations. For example, a conditional output generation system, e.g., the conditional output generation system 100 of FIG. 1, appropriately programmed in accordance with this specification, can perform the process 200.

The system obtains a network input (202) on which to condition a final network output. For example, for a network output that is an audio waveform, the network input can be a spectrogram, mel-spectrogram, or linguistic features of a body of text reflected by the audio waveform.

The system initializes a current network output (204). For a final network output including multiple values, the system can sample each value in an initial current network output having the same number of values as the final network output from a noise distribution. For example, the system can initialize a current network output using a noise distribution (e.g., a Gaussian noise distribution), represented by yₙ ~ N(0, I), where I is an identity matrix and the N in y_{N} represents the intended number of iterations. The system can update the initial current network output over the N iterations, from iteration N to iteration 1, in descending order.

The system then updates the current network output at each of multiple iterations. Generally, the current network output at each iteration can be interpreted as the final network output with additional noise. That is, the current network outputs are noisy versions of the final network output. For example, for an initial current network output yₙ, where N represents the number of iterations, the system can update the current network output at each of iterations N through 1 by removing an estimate for the noise corresponding to the iteration. That is, the system can refine the current network output at each iteration by determining an estimate for the noise and updating the current network output in accordance with the estimate. The system can use a descending order for the iterations until outputting the final network output, y_{0.}

At each of the multiple iterations, the system generates a noise output for the iteration by processing a model input including (1) the current network output, (2) the network input, and optionally (3) iteration-specific data for the iteration (206) using a noise estimation neural network. The iteration-specific data is generally derived from noise levels for the iterations, where each noise level corresponds to a particular iteration. The noise output can include a noise estimate for each value in the current network output. For example, the respective noise estimate for a particular value in the current network output can represent an estimate of the noise that has been added to the corresponding actual value in an actual network output for the network input to generate the particular value. That is, the noise estimate for the particular value would represent how the actual value, if known, would need to be modified given the corresponding noise level to generate the particular value.

At each of the multiple iterations, the system updates the current network output as of the current iteration using the noise output for the current iteration and the noise level corresponding to the current iteration (208). The system can update each value in the current network output using the corresponding noise estimate in the noise output and the noise level for the current iteration. The system can generate an update for the iteration from the noise estimate and noise level for the iteration, and then subtract the update from the current network output to generate an initial updated network output. Then, the system can modify the initial updated network output based on the noise level for the iteration to generate a modified initial updated network output, as,

$${y}_{n - 1} = \frac{1}{\sqrt{{α}_{n}}} \left({y}_{n} - \frac{1 - {α}_{n}}{\sqrt{1 - {\overline{α}}_{n}}} {ε}_{θ} \left({y}_{n} , x , \sqrt{{\overline{α}}_{n}}\right)\right) , \qquad \text{(1)}$$

where n indexes the iterations, yₙ represents the current network output at iteration n, yₙ₋₁ represents the modified initial updated network output, x represents the network input, αₙ represents the noise level for iteration n, α̅ₙ represents an aggregate noise level for iteration n (e.g., which is generated from the noise levels at the current iteration and at any iteration after the current iteration), and

$${ε}_{θ} \left({y}_{n} , x , \sqrt{{\overline{α}}_{n}}\right)$$

represents the noise output generated by the noise estimation neural network with parameters θ. The noise level αₙ and aggregate noise level α̅ₙ can be determined from a noise schedule

$${\left\{{β}_{n}\right\}}_{n = 1}^{N}$$

(e.g., a linear noise schedule ranging linearly from a minimum value to a maximum value, a Fibonacci-based schedule, or a custom schedulegenerated from data-driven or heuristic methods). The noise level αₙ = 1 -βₙ, and the aggregate noise level α̅ₙ can be sampled from a uniform distribution as

$$\sqrt{{\overline{α}}_{n}} \sim U \left({l}_{n - 1} , {l}_{n}\right) , \qquad \text{(2)}$$

where n indexes the iterations,

$${l}_{0} = 1 , ∀ n > 0 : {l}_{n} = \sqrt{{\prod }_{i = 1}^{n} \left({α}_{i}\right)} .$$

Sampling

$$\sqrt{{\overline{α}}_{n}}$$

as in equation (2) enables to system to generate updates based on different scales of noise. The noise level αₙ and aggregate noise level α̅ₙ for each iteration n can be predetermined and obtained by the system as a part of the model input.

For the last iteration, the modified initial updated network output is the updated network output after the last iteration and, for each iteration prior to the last iteration, the updated network output after the last iteration is generated by adding noise to the modified initial updated network output. That is, if the iteration is not the final iteration (that is, if n > 1), the system further updates the modified initial updated network output as,

$${y}_{n - 1} = {y}_{n - 1} + {σ}_{n} z , \qquad \text{(3)}$$

where n indexes the iterations, σₙ can be determined from the noise schedule

$${\left\{{β}_{n}\right\}}_{n = 1}^{N}$$

or another method (e.g., as a function of the noise schedule, or determined via hyper-parameter tuning using empirical experiments), and z ~ N(0, I). The σₙ is included to enable modeling the multi-modal distribution.

The system determines whether or not the termination criteria have been met (210). For example, the termination criteria can include having performed a specific number of iterations (e.g., determined to meet a minimum performance metric, a maximum latency requirement, or a maximum computation resource requirement such as maximum number of FLOPS). If the specific number of iterations have not been performed, the system can begin again from step (206) and perform another update to the current network output.

If the system determines that the termination criteria have been met, the system outputs a final network output (212), which is the updated network output after the final iteration.

The process 200 can be used to generate network outputs in a non-autoregressive manner conditioned on network inputs. Generally, auto-regressive models have been shown to generate high quality network outputs but require a large number of iterations, resulting in high latency and resource, e.g., memory and processing power, consumption. This is because auto-regressive models generate each given output within a network output one by one, with each being conditioned on all of the outputs that precede the given output within the network output. The process 200, on the other hand, start from an initial network output, e.g., a noisy output that includes values sampled from a noise distribution, and iteratively refine the network output via a gradient-based sampler conditioned on the network input. As a result, the approach is non-autoregressive and requires only a constant number of generation steps during inference. For example, for audio synthesis conditioned on a spectrogram, the described techniques can generate high fidelity audio samples in very few iterations, e.g., six or fewer, that compare to or even exceed those generated by state of the art autoregressive models with greatly reduced latency and while using many fewer computational resources.

FIG. 3 shows an example architecture of the noise estimation network 300.

The example noise estimation network 300 includes multiple types of neural network layers and neural network blocks (e.g., where each neural network block includes multiple neural network layers), including convolutional neural network layers, noise generation neural network blocks, Feature-wise Linear Modulation (FiLM) module neural network blocks, and network output processing neural network blocks.

The noise estimation network 300 processes a model input including (1) a current network output 114, (2) a network input 102, and (3) iteration-specific data including aggregate noise level 306 corresponding to the current iteration to generate a noise output 110. The network output 114 has a higher dimensionality than the network input 102, and the noise output 110 has a same dimensionality as the current network output 114. For example, for a current network output representing an audio waveform at 24 kHz, the network input can include an 80 Hz mel-spectrogram signal corresponding to the audio waveform (e.g., predicted by another system during inference).

The noise estimation network 300 includes multiple network output processing blocks to process the current network output 114 to generate respective alternative representations of the current network output 114.

The noise estimation network 300 also includes a network output processing block 400 to process the current network output 114 to generate an alternative representation of the current network output, where the alternative representation has a smaller dimensionality than the current network output.

The noise estimation network 300 further includes additional network output processing blocks (e.g., network output processing blocks 318, 316, 314, and 312) to process the alternative representation generated by a previous network output processing block to generate another alternative representation having a yet smaller dimensionality than the previous alternative representation (e.g., network 318 processes the alternative representation from block 400 to generate an alternative representation with a smaller dimensionality than the output of block 400, block 316 processes the alternative representation from block 318 to generate an alternative representation with a smaller dimensionality than the output of block 318, etc.). The alternative representation of the current network output generated from the final network output processing block (e.g., 312) has the same dimensionality as the network input 102.

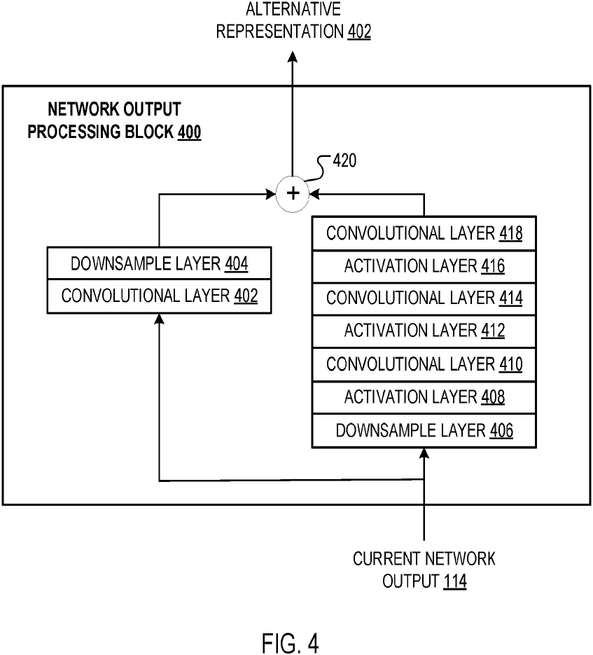

For example, for a current network output including an audio waveform of 24 kHz and a network input including a mel-spectrogram of 80 Hz, the network output processing block blocks can “downsample” the dimensionality (that is, reduce the dimensionality) by factors of 2, 2, 3, 5, and 5 (e.g., by network output processing blocks 400, 318, 316, 314, and 312, respectively) until the alternative representation produced by the final layer 312 is 80 Hz (i.e., reduced by a factor of 300 to match the mel-spectrogram). The architecture of an example network output processing block is discussed in further detail with respect to FIG. 4.

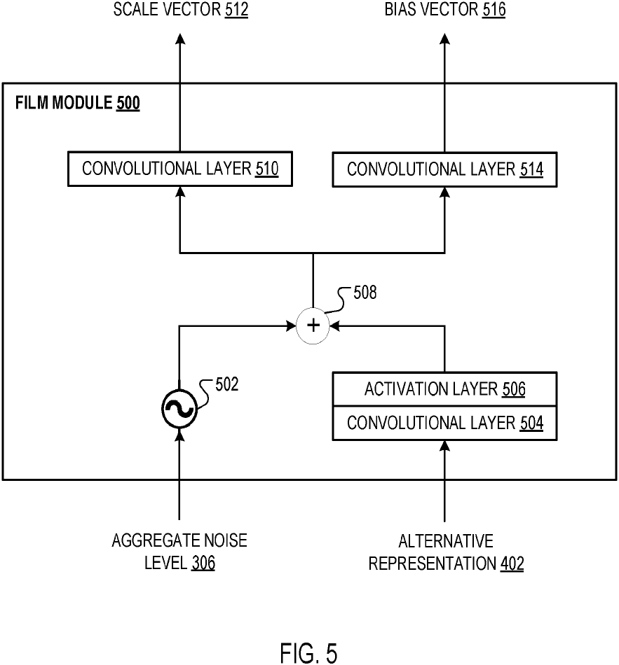

The noise estimation block 300 includes multiple FiLM module neural network blocks to process the iteration-specific data (e.g., aggregate noise level 306) corresponding to the current iteration and the alternative representations from the network output processing neural network blocks to generate inputs for the noise generation neural network blocks. Each FiLM module processes the aggregate noise level 306 and the alternative representation from a respective network output processing block to generate an input for a respective noise generation block (e.g., FiLM module 500 processes the alternative representation from network output processing block 400 to generate an input for noise generation block 600, FILM module 328 processes the alternative representation from network output processing block 318 to generate an input for noise generation block 338, etc.). In particular, each FiLM module generates a scale vector and a bias vector as input to a respective noise generation block (e.g., as input to affine transformation neural network layers within the respective noise generation block), as is discussed in further detail with reference to FIG. 5.

The noise estimation network 300 includes multiple noise generation neural network blocks to process the network input 102 and the output from the FiLM modules to generate the noise output 110. The noise estimation network 300 can include a convolutional layer 302 to process the network input 102 to generate an input to a first noise generation block 332, and a convolutional layer 304 to process output from a final noise generation block 600 to generate the noise output 110. Each noise generation block generates an output that has a higher dimensionality than the network input 102. In particular, each noise generation block after the first generates an output that has a higher dimensionality than the output from the previous noise generation block. The final noise generation block generates an output with a same dimensionality as the current network output 114.

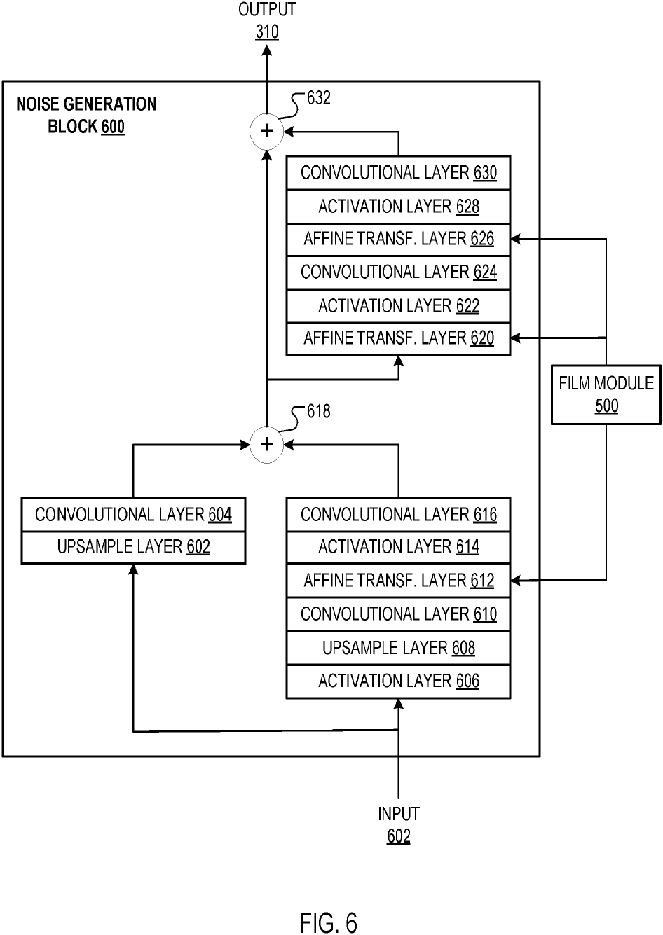

The noise estimation network 300 includes a noise generation block 332 to process the output from the convolutional layer 302 (i.e., the convolution layer that processes the network input 102) and the output from the FILM module 332 to generate an input to a noise generation block 334. The noise estimation network 300 further includes noise generation blocks 336, 338, and 600. Noise generation blocks 334, 336, 338, and 600 each process the output from a respective previous noise generation block (e.g., block 334 processes the output from block 332, block 336 processes the output from block 334, etc.) and the output from a respective FiLM module (e.g., noise generation block 334 processes the output from FILM module 324, noise generation block 336 processes the output from FILM module 326, etc.) to generate an input for the next neural network block. The noise generation block 600 generates an input for a convolutional layer 304 which processes the input to generate the noise output 110. The architecture of an example noise generation block (e.g., noise generation block 600) is discussed in further detail with respect to FIG. 6.

Each noise generation block prior to the last can generate an output that has the same dimensionality as the corresponding alternative representation of the current network output (e.g., noise generation block 332 generates an output with a dimensionality equal to the alternative representation generated by the network output processing block 314, noise generation block 334 generates an output with a dimensionality equal to the output from network output processing block 316, etc.).

For example, for a current network output including an audio waveform of 24 kHz and a network input including a mel-spectrogram of 80 Hz, the noise generation blocks can “upsample” the dimensionality (that is, increase the dimensionality) by factors of 5, 5, 3, 2, and 2 (e.g., by noise generation blocks 332, 334, 336, 338, and 600, respectively) until the output of the final noise generation block (e.g., noise generation block 600) is 24 kHz (i.e., increased by a factor of 300 to match the current network output 114).

FIG. 4 shows an example architecture of the network output processing block 400.

The network output processing block 400 processes a current network output 114 to generate an alternative representation 402 of the current network output 114. The alternative representation has a smaller dimensionality than the current network output. The network output processing block 400 includes one or more neural network layers. The one or more neural network layers can include multiple types of neural network layers, including downsampling layers (e.g., to “downsample” or reduce the dimensionality of an input), activation layers having non-linear activation functions (e.g., a fully-connected layer with a leaky ReLU activation function), convolutional layers, and a residual connection layer.

For example, a downsample layer can be a convolutional layer with the necessary stride to reduce (“downsample”) the dimensionality of the input. In a particular example, a stride of X can be used to reduce the dimensionality of the input by a factor of X (e.g., a stride of two can be used to reduce the dimensionality of the input by a factor of two; a stride of five can be used to reduce the dimensionality of the input by a factor of five, etc.).

The left branch of a residual connection layer 420 includes a convolutional layer 402 and a downsample layer 404. The convolutional layer 402 processes the current network output 114 to generate an input to the downsample layer 404. The downsample layer 404 processes the output from the convolutional layer 402 to generate an input to the residual connection layer 420. The output of the downsample layer 404 has a reduced dimensionality compared with the current network output 114. For example, the convolutional layer 402 can include filters of size 1×1 with stride 1 (i.e., to maintain the dimensionality), and the downsample layer 404 can include filters of size 2×1 with a stride of two to downsample the dimensionality of the input by a factor of two.

The right branch of the residual connection layer 420 includes a downsample layer 406 and three subsequent blocks of an activation layer followed by a convolutional layer (e.g., activation layer 408, convolutional layer 410, activation layer 412, convolutional layer 414, activation layer 416, and convolutional layer 418). The downsample layer 406 processes the current network output 114 to generate the input for subsequent three blocks of activation and convolutional layers. The output of the downsample layer 406 has a smaller dimensionality compared with the current network input 114. The subsequent three blocks process the output from the downsample layer 406 to generate an input to the residual connection layer 420. For example, the downsample layer 406 can include filters of size 2×1 with stride two to reduce the dimensionality of the input by a factor of two (e.g., to properly match downsample layer 404). The activation layers (e.g., 408, 412, and 416) can be fully-connected layers with leaky ReLU activation functions. The convolutional layers (e.g., 410, 414, and 418) can include filters of size 3×1 with stride one (i.e., to maintain dimensionality).

The residual connection layer 420 combines the output from the left branch and the output from the right branch to generate the alternative representation 402. For example, the residual connection layer 420 can add (e.g., elementwise addition) the output from the left branch and the output from the right branch to generate the alternative representation 402.

FIG. 5 shows an example Feature-wise Linear Modulation (FiLM) module 500.

The FiLM module 500 processes an alternative representation 402 of a current network output and an aggregate noise level 306 corresponding to the current iteration to generate a scale vector 512 and a bias vector 516. The scale vector 512 and the bias vector 516 can be processed as input to specific layers (e.g., affine transformation layers) in a respective noise generation block (e.g., noise generation block 600 in the noise estimation network 300 of FIG. 3). The FiLM module 500 includes a positional encoding function and one or more neural network layers. The one or more neural network layers can include multiple types of neural network layers, including residual connection layers, convolutional layers, and activation layers having non-linear activation functions (e.g., a fully-connected layer with a leaky ReLU activation function).

The left branch of a residual connection layer 508 includes a position encoding function 502. The positional encoding function 502 processes the aggregate noise level 306 to generate a positional encoding of the noise level. For example, the aggregate noise level 306 can be multiplied by a positional encoding function 502 that is a combination of sine function for even dimension indices and a cosine function for odd dimension indices, as in pre-processing for a transformer model.

The right branch of the residual connection layer 508 includes a convolutional layer 504 and an activation layer 506. The convolutional layer 504 processes the alternative representation 402 to generate an input to the activation layer 506. The activation layer 506 processes the output from the convolutional layer 504 to generate an input to the residual connection layer 508. For example, the convolutional layer 504 can include filters of size 3x1 with stride one (to maintain dimensionality), and the activation layer 506 can be a fully-connected layer with a leaky ReLU activation function.

The residual connection layer 508 can combine the output from the left branch (e.g., the output from the positional encoding function 502) and the output from the right branch (e.g., the output from the activation layer 506) to generate an input to both a convolutional layer 510 and a convolutional layer 514. For example, the residual connection layer 508 can add (e.g., elementwise addition) the output from the left branch and the output from the right branch to generate the input to the two convolutional layers (e.g., 510 and 514).

The convolutional layer 510 processes the output from the residual connection layer 508 to generate the scale vector 512. For example, the convolutional layer 510 can include filters of size 3x1 with stride one (to maintain dimensionality).

The convolutional layer 514 processes the output from the residual connection layer 508 to generate the bias vector 516. For example, the convolutional layer 514 can include filters of size 3x1 with stride one (to maintain dimensionality).

FIG. 6 shows an example noise generation network 600. The noise generation network 600 is an example of a system implemented as computer programs on one or more computers in one or more locations in which the systems, components, and techniques described below are implemented.

The noise generation block 600 is an example neural network architecture of a noise generation block used in a noise estimation neural network, e.g., the noise estimation network 300 of FIG. 3.

The noise generation block 600 processes an input 602 and an output from a FiLM module 500 to generate an output 310. The input 602 can be a network input processed by one or more previous neural network layers (e.g., from the noise generation blocks 338, 336, 334, 332, and convolutional layer 302 of FIG. 3). The output 310 can be an input to a subsequent convolutional layer which will process the output 310 to generate the noise output 110 (e.g., the convolutional layer 304 of FIG. 3). The noise generation block 600 includes one or more neural network layers. The one or more neural network layers can include multiple types of neural network layers, including activation layers with non-linear activation functions (e.g., fully-connected layers with leaky ReLU activation functions), upsample layers (e.g., which “upsample” or increase the dimensionality of the input), convolutional layers, affine transformation layers, and residual connection layers.

For example, an upsample layer can be a neural network layer which “upsamples” (that is, increases) the dimensionality of an input. That is, an upsample layer generates an output that has a higher dimensionality than the input to the layer. In a particular example, the upsample layer can generate an output with X copies of each value in the input to increase the dimensionality of the output compared with the input by a factor of X (e.g., for an input (2,7,-4), generate an output with two copies of each value as (2,2,7,7,-4,-4), or five copies of each value as (2,2,2,2,2,7,7,7,7,7,-4,-4,-4,-4,-4), etc.). Generally, the upsample layer can fill each extra spot in the output with the nearest value in the input.

The left branch of a residual connection layer 618 includes an upsample layer 602 and a convolutional layer 604. The upsample layer 602 processes the input 602 to generate an input to the convolutional layer 604. The input to the convolutional layer has a higher dimensionality than the input 602. The convolutional layer 604 processes the output from the upsample layer 602 to generate an input to the residual connection layer 618. For example, the upsample layer can increase the dimensionality of the input by a factor of two by generating an output with two copies of each value in the input 602. The convolutional layer 604 can include filters with dimensions 3x1 and stride one (e.g., to maintain dimensionality).

The right branch of the residual connection layer 618 includes an activation layer 606 (e.g., a fully-connected layer with a leaky ReLU activation function), an upsample layer 608, a convolutional layer 610 (e.g., with a 3x1 filter size and stride one), an affine transformation layer 612, an activation layer 614 (e.g., a fully-connected layer with a leaky ReLU activation function), and a convolutional layer 616 (e.g., with a 3x1 filter size and stride one), in that order.

The activation layer 606 processes the input 602 to generate an input to the upsample layer 608. The upsample layer increases the dimensionality of the output from the activation layer 606 to generate an input to the convolutional layer 610 with a higher dimensionality than the input 602 (e.g., by a factor of two to match upsample layer 602). The convolutional layer 610 processes the output from upsample layer 608 to generate an input to the affine transformation layer 612 (e.g., with filters of dimensions 3x1 and stride one to maintain dimensionality). The activation layer 614 and convolutional layer 616 further process the output from affine transformation layer 612 to generate an input to the residual connection layer 618 (e.g., with a leaky ReLU function for network 614 and filters of dimensions 3x1 and stride one for network 616).

For example, an affine transformation function can process the output from a preceding neural network layer (e.g., the convolutional layer 610 in the noise generation block 600) and the output from a FiLM module to generate an output. For example, the FiLM module can generate a scale vector and a bias vector. The affine transformation layer can add the bias vector to the result of scaling (e.g., using a Hadamard product, or elementwise multiplication) the output from the previous neural network layer using the scale vector from the FiLM module.

The affine transformation layer 612 can process the output from convolutional layer 610 and the output from FiLM module 500 to generate the input to the activation layer 614. For example, by adding the bias vector from FiLM module 500 to the result of scaling the output from convolutional layer 610 with the scale vector from FiLM module 500.

The residual connection layer 618 combines the output from the left branch (e.g., the output from the convolutional layer 604) and the output from the right branch (e.g., the output from convolutional layer 616) to generate an output. For example, the residual connection layer 618 can sum the output from the left branch and the output from the right branch to generate the output.

The left branch of a residual connection layer 632 includes the output from the residual connection layer 618. The left branch can be interpreted as an identity function of the output from the residual connection layer 618.

The right branch of the residual connection layer 632 includes two sequential blocks of an affine transformation layer, an activation layer, and a convolutional layer, in that order, to process the output from residual connection layer 618 and to generate an input to residual connection layer 632. In particular, the first block contains affine transformation layer 620, activation layer 622, and convolutional layer 624. The second block contains affine transformation layer 626, activation layer 628, and convolutional layer 630.

For example, for each block, the respective affine transformation layer can process the output from the FiLM module 500 and the output from the respective previous neural network layer (e.g., affine transformation layer 620 can process the output from residual connection layer 618, and affine transformation layer 626 can process the output from the convolutional layer 624) to generate a respective output. Each affine transformation layer can generate the respective output by scaling the output from the previous neural network layer with the scale vector from the FiLM module 500 and summing the result of the scaling with the bias vector from the FiLM module 500. Each activation layer (e.g., 620 and 628) can be a respective fully-connected layer with a leaky ReLU activation function. Each convolutional layer can include respective filters of dimensions 3x1 and stride one (e.g., to maintain dimensionality).

The residual connection layer 632 combines the output from the left branch (e.g., the identity of the output from residual connection layer 618) and the output from the right branch (e.g., the output from the convolutional layer 630) to generate the output 310. For example, the residual connection layer 632 can sum the output from the left branch and the output from the right branch to generate output 310. The output 310 can be an input to a convolutional layer (e.g., the convolutional layer 304 of FIG. 3) which will generate the noise output 110.

The noise generation block 600 can include multiple channels. Each noise generation block in FIG. 3 (e.g., 600, 338, 336, 334, and 332) can include respective numbers of channels. For example, the noise generation blocks 600, 338, 336, 334, and 332 can include 128, 128, 256, 512, and 512 channels, respectively.

FIG. 7 is a flow diagram of an example process for training a noise estimation neural network. For convenience, the process 700 will be described as being performed by a system of one or more computers located in one or more locations.

The system can perform the process 700 at each of multiple training iterations to repeatedly update the values of the parameters of the noise estimation neural network.

The system obtains a batch of training network input - training network output pairs (702). For example, the system can randomly sample training pairs from a data store. For example, each training network output can be an audio waveform, and each network input can be a ground-truth mel-spectrogram computed from the corresponding audio waveform.

For each training pair in the batch, the system selects iteration-specific data from a set that includes iteration-specific data for all of the iterations (704). For example, the system can sample a particular iteration from a discrete uniform distribution including integers one through the final iteration, then select the iteration-specific data based on the particular iteration sampled from the distribution. The iteration-specific data can include a noise level, an aggregate noise level, (e.g., as determined in equation (2)), or the iteration number itself. Thus the system can condition the noise estimation neural network on a discrete index, or can condition the noise estimation neural network on a continuous scalar indicating a noise level. Conditioning on a continuous scalar indicating a noise level can be advantageous, as once the noise estimation neural network is trained, a different number of refinement steps (i.e. iterations) can be used when generating a final network output at inference.

For each training pair in the batch, the system samples a noisy output that includes a respective noise value for each value in the training network output (706). For example, the system can sample the noisy output from a noise distribution. In a particular example, the noise distribution can be a Gaussian noise distribution (e.g., such as N(0, I), where I is an identity matrix with dimensions n x n, and where n is the number values in the training network output).

For each training pair in the batch, the system generates a modified training network output from the noisy output and the corresponding training network output (708). The system can combine the noisy output and the corresponding training network output to generate the modified training network output. For example, the system can generate the modified training network output as,

$${y}^{′} = \sqrt{\overline{α}} {y}_{0} + \sqrt{1 - \overline{α}} ε , \qquad \text{(4)}$$

where y′ represents the modified training network output, y₀ represents the corresponding training network output, ∈ represents the noisy output, and

$$\sqrt{\overline{α}}$$

represents the iteration-specific data (e.g., an aggregate noise level).

For each training pair in the batch, the system generates a training noise output by processing a model input including (1) the modified training network output, (2) the training network input, and (3) the iteration-specific data using the noise estimation neural network in accordance with current values of the network parameters (710). The noise estimation neural network can process the model input to generate the training noise output as described in the process of FIG. 2. For example, the iteration-specific criteria can include the aggregate noise level √ā.

The system determines an update to the network parameters of the noise estimation network from a gradient of an objective function (712) for the training batch. The system can determine the gradient of the objective function with respect to the neural network parameters of the noise estimation network for each training pair, and then update the current values of the neural network parameters with the gradients (e.g., a linear combination of the gradients, such as an average of the gradients) using any of a variety of appropriate optimization methods, such as stochastic gradient descent with momentum, or ADAM.

The objective function can measure an error between the noisy output and the training noise output generated by the noise estimation network for each training pair. For example, for a particular training pair, the objective function can include a loss term which measures an L1 distance between the noisy output and the training noise output, as

$$L \left(ε , {ε}_{θ}\right) = {\left‖ε - {ε}_{θ} \left({y}^{′} , x , \sqrt{\overline{α}}\right)\right‖}_{1} , \qquad \text{(5)}$$

where L(∈, ∈_{θ}) represents the loss function, ∈ represents the noisy output,

$${ε}_{θ} \left({y}^{′} , x , \sqrt{\overline{α}}\right)$$

represents the training noise output generated by the noise estimation neural network with parameters θ, y′ represents the modified training network output, x represents the training network input, and √ā represents the iteration-specific data (e.g., an aggregate noise level).

The system can repeatedly perform steps (702) - (712) for multiple batches (e.g., multiple batches of training network input - training network output pairs).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of generating a final network output comprising a plurality of outputs conditioned on a network input, the method comprising:
obtaining the network input;
initializing a current network output; and
generating the final network output by updating the current network output at each of a plurality of iterations, wherein each iteration corresponds to a respective noise level, and wherein the updating comprises, at each iteration:
processing a model input for the iteration comprising (i) the current network output and (ii) the network input using a noise estimation neural network that is configured to process the model input to generate a noise output, wherein the noise output comprises a respective noise estimate for each value in the current network output; and
updating the current network output using the noise estimate and the noise level for the iteration.

2. The method of claim 1, wherein the network input is a spectrogram of an audio segment, and wherein the final network output is a waveform for the audio segment.

3. The method of claim 2, wherein the audio segment is a speech segment.

4. The method of claim 3, wherein the spectrogram has been generated from a text segment or linguistic features of the text segment by a text-to-speech model.

5. The method of claim 2, wherein the spectrogram is a mel spectrogram or a log mel spectrogram.

6. The method of claim 1, wherein either:
the network input is a class of an object specifying a class of image object to be generated, and the network output is a generated image of the class of object, or
the network input is a sequence of text, and the network output is an image that reflects the text, or
the network input is an image, and the network output is a numeric embedding of the input image that characterizes the image, or
the network input is an image, and the network output identifies locations in the input image at which particular types of objects are depicted, or
the network input is an image, and the network input is a segmentation output that assigns each of a plurality of pixels of the input image to a category from a set of categories.

7. The method of claim 1, wherein updating the current network output using the noise estimate and the noise level for the iteration comprises:
generating an update for the iteration from at least the noise estimate and the noise level corresponding to the iteration; and
subtracting the update from the current network output to generate an initial updated network output.

8. The method of claim 7, wherein updating the current network output further comprises:
modifying the initial updated network output based on the noise level for the iteration to generate a modified initial updated network output.

9. The method of claim 8, wherein, for the last iteration, the modified initial updated network output is the updated network output after the last iteration and, for each iteration prior to the last iteration, the updated network output after the last iteration is generated by adding noise to the modified initial updated network output.

10. The method of claim 1, wherein initializing the current network output comprises: sampling each of a plurality of initial values for the current network output from a corresponding noise distribution.

11. The method of claim 1, wherein the model input at each iteration includes iteration-specific data that is different for each iteration.

12. The method of claim 11, wherein the model input for each iteration includes the noise level corresponding to the iteration.

13. The method of claim 11, wherein the model input for each iteration includes an aggregate noise level for the iteration generated from the noise levels corresponding to the iteration and to any iterations after the iteration in the plurality of iterations.

14. The method of claim 11, wherein the noise estimation neural network comprises:
a noise generation neural network comprising a plurality of noise generation neural network layers and configured to process the network input to map the network input to the noise output, and
a network output processing neural network comprising a plurality of network output processing neural network layers configured to process the current network output to generate an alternative representation of the current network output, wherein:
at least one of the noise generation neural network layers receives an input that is derived from (i) an output of another one of the noise generation neural network layers, (ii) an output of a corresponding network output processing neural network layer, and (iii) the iteration-specific data for the iteration.

15. The method of claim 14, wherein the final network output has a higher dimensionality than the network input, and wherein the alternative representation has a same dimensionality as the network input.

16. The method of claim 14, wherein the noise estimation neural network comprises a respective Feature-wise Linear Modulation (FiLM) module corresponding to each of the at least one noise generation neural network layers, wherein the FiLM module corresponding to a given noise generation neural network layer is configured to process (i) the output of the other one of the noise generation neural network layers, (ii) the output of the corresponding network output processing neural network layer, and (iii) the iteration-specific data for the iteration to generate the input to the noise generation neural network layer.

17. The method of claim 16, wherein the FiLM module corresponding to the given noise generation neural network layer is configured to:
generate a scale vector and a bias vector from (ii) the output of the corresponding network output processing neural network layer, and (iii) the iteration-specific data for the iteration; and
generate the input to the given noise generation neural network layer by applying an affine transformation to the output of (i) the other one of the noise generation neural network layers.

18. The method of claim 14, wherein the at least one of the noise generation neural network layers includes an activation function layer that applies a non-linear activation function to the input to the activation function layer.

19. The method of claim 18, wherein the other one of the noise generation neural network layers corresponding to the activation function layer is a residual connection layer or a convolutional layer.

20. A method of training a noise estimation neural network, wherein the noise estimation neural network is configured to receive a model input for a given iteration comprising (i) a current network output as of the given iteration, (ii) the network input using a noise estimation neural network that is configures to process the model input to generate a noise output, and (iii) iteration-specific data for the given iteration, wherein the noise output comprises a respective noise estimate for each value in the current network output, and wherein the method repeatedly performing the following operations:
obtaining a training network input and a corresponding training network output;
selecting iteration-specific data from a set that includes respective iteration-specific data for each of a plurality of iterations;
sampling a noisy output that includes a respective noise value for each value in the training network output;
generating a modified training network output from the noisy output and the corresponding training network output;
processing a model input that comprises (i) the modified training network output, (ii) the training network input, and (iii) the iteration-specific data using the noise estimation neural network to generate a training noise output; and
determining an update to the network parameters of the noise estimation neural network from a gradient of an objective function that measures an error between the sampled noisy output and the training noise output.

21. The method of claim 20, wherein the objective function measures a distance between the sampled noisy output and the training noise output.

22. The method of claim 21, wherein the distance is an L1 distance.

23. A system comprising one or more computers and one or more storage devices storing instructions that are operable, when executed by the one or more computers, to cause the one or more computers to perform operations for generating a final network output comprising a plurality of outputs conditioned on a network input, the operations comprising;
obtaining the network input,
initializing a current network output and
generating the final network output by updating the current network output at each of a plurality of iterations, wherein each iteration corresponds to a respective noise level, and wherein the updating comprises, at each iteration.
processing a model input for the iteration comprising (i) the current network output and (ii) the network input using a noise estimation neural network that is configured to process the model input to generate a noise output, wherein the noise output comprises a respective noise estimate for each value in the current network output; and
updating the current network output using the noise estimate and the noise level for the iteration.

24. (canceled)
